(19) United States
(12) Patent Application Publication
(10) Pub. No.: US 2024/0089772 A1
(43) Pub. Date: Mar. 14, 2024

(54) METHOD AND DEVICE FOR WIRELESS COMMUNICATION

(71) Applicants: Yu CHEN, SHANGHAI (CN); Xiaobo ZHANG, SHANGHAI (CN)

(72) Inventors: Yu CHEN, SHANGHAI (CN); Xiaobo ZHANG, SHANGHAI (CN)

(73) Assignee: SHANGHAI LANGBO COMMUNICATION TECHNOLOGY COMPANY LIMITED, Shanghai (CN)

(21) Appl. No.: 18/242,530

(22) Filed: Sep. 6, 2023

(30) Foreign Application Priority Data
Sep. 9, 2022 (CN) 202211103367.7

(51) Int. Cl. H04W 24/10

(52) U.S. Cl. CPC H04W 24/10

(57) ABSTRACT

The present application discloses a method and a device for wireless communications, including: receiving a first signaling, the first signaling comprising a first measurement gap configuration, the first measurement gap configuration comprising that frequencies corresponding to measurement gaps are configured as a first frequency set; and determining a first measurement gap set according to the first measurement gap configuration; the first measurement gap set comprising at least two measurement gaps; herein, any transmission or reception for a serving cell on the first frequency set within the first measurement gap set other than RRM measurement and PRS measurement is ignored; any two measurement gaps in the first measurement gap set are orthogonal and non-consecutive in time domain. By determining the first measurement gap set in a rational way, the present application contributes to network optimization and enhances the reliability of communications for avoidance of interruption.

### CROSS REFERENCE TO RELATED APPLICATIONS

This application claims the priority benefit of Chinese Patent Application No. 202211103367.7, filed on Sep. 9, 2022, the full disclosure of which is incorporated herein by reference.

### BACKGROUND

### Technical Field

The present application relates to transmission methods and devices in wireless communication systems, in particular to a method and device for reducing traffic interruptions, enhancing QoS of traffics and optimizing network measurement in communications.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 plenary to standardize the NR.

In communications, both Long Term Evolution (LTE) and 5G NR involves correct reception of reliable information, optimized energy efficiency ratio (EER), determination of information validity, flexible resource allocation, elastic system structure, effective information processing on non-access stratum (NAS), and lower traffic interruption and call drop rate, and support to lower power consumption, which play an important role in the normal communication between a base station and a User Equipment (UE), rational scheduling of resources, and also in the balance of system payload, thus laying a solid foundation for increasing throughput, meeting a variety of traffic needs in communications, enhancing the spectrum utilization and improving service quality. Therefore, LIE and 5G are indispensable no matter in enhanced Mobile BroadBand (eMBB), Ultra Reliable Low Latency Communication (URLLC) or enhanced Machine Type Communication (eMTC). And a wide range of requests can be found in terms of Industrial Internet of Things (IIoT), Vehicular to X (V2X), and Device to Device (D2D), Unlicensed Spectrum communications, and monitoring on UE communication quality, network plan optimization, Non Terrestrial Network (NTN) and Terrestrial Network (TN), Dual connectivity system, or combined, radio resource management and multi-antenna codebook selection, as well as signaling design, neighbor management, traffic management and beamforming. Information is generally transmitted by broadcast and unicast, and both ways are beneficial to fulfilling the above requests and make up an integral part of the 5G system. The UE's connection with the network can be achieved directly or by relaying.

As the number and complexity of system scenarios increases, more and more requests have been made on reducing interruption rate and latency, strengthening reliability and system stability, increasing the traffic flexibility and power conservation, and in the meantime the compatibility between different versions of systems shall be taken into account for system designing.

Refer to 3GPP specifications for the concepts, terminology and abbreviations given in the present application, including but not limited to:
https://www.3gpp.org/ftp/Spec s/archive/21_series/21.905/21905-h10.zip
https://www.3gpp.org/ftp/Spec s/archive/38_series/38.300/38300-h10.zip
https://www.3gpp.org/ftp/Spec s/archive/38_series/38.331/38331-h10.zip
https://www.3gpp.org/ftp/Spec s/archive/38_series/38.321/38321-h10.zip
https://www.3gpp.org/ftp/Spec s/archive/38_series/38.304/38304-h10.zip

### SUMMARY

In multiple communication scenarios a User Equipment (terminal/UE) needs to perform measurements, especially those of inter-frequency networks and inter-RAT networks, which are generally supposed to be performed during measurement gaps configured by the networks. During measurement gaps, for instance when performing measurements, the reception or transmission of the UE may be restricted, i.e., the UE is unable to receive on different frequencies simultaneously. Generally, the network can help prevent the UE from receiving or transmitting data during the measurement gaps by dynamic scheduling or proper configuration of the measurement gaps. But for some services, such as XR services, referring to VR, AR and CG services combined, which are featured by high rate and low latency and are interactive all the time, any occurrence of delay or error in the reception of the services will have a serious impact on the users' experience. Some typical XR services have non-integral transmission periods, but the period of measurement gaps is integral, which makes the conflict between the measurement gaps and transceiving of XR services inevitable. Such conflict can hardly be avoided through proper configuration of the period or start time of measurement gaps. When there occurs the conflict, it is likely to lead to a temporary interruption of the reception or transmission of XR services. The measurement gap may be up to 20 ms, besides, switching between different frequencies also requires an extra transition time, which jointly will result in a more-than-20 ms interruption, and an interruption as long as over 20 ms is severe for such high-speed service as XR. Therefore, how to avoid conflicts between measurement gaps and the XR service transmission is an issue to be solved by the present application.

To address the problem presented above, the present application provides a solution.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict. Besides, the method proposed in the present application can also address other issues confronting communications.

The present application provides a method in a first node for wireless communications, comprising:
receiving a first signaling, the first signaling comprising a first measurement gap configuration, the first measurement gap configuration comprising that frequencies corresponding to measurement gaps are configured as a first frequency set; and
determining a first measurement gap set according to the first measurement gap configuration; the first measurement gap set comprising at least two measurement gaps;
herein, any transmission or reception for a serving cell on the first frequency set within the first measurement gap set other than RRM measurement and PRS measurement is ignored; any two measurement gaps in the first measurement gap set are orthogonal and non-consecutive in time domain; candidates of a time interval between any two time-domain adjacent measurement gaps in the first measurement gap set include a first time interval and a second time interval, where the first time interval is unequal to the second time interval.

In one embodiment, a problem to be solved in the present application includes: how to configure measurement gaps properly, and how to ensure that the measurement gaps won't affect the reception or transmission of traffics, and how to avoid conflicts that may occur between the measurement gaps and XR traffics and/or traffics with non-integral periodicity; how to determine a measurement gap according to the reception of traffics as well as the measurement gap configuration.

In one embodiment, an advantage of the above method includes: guaranteeing the quality of communications, avoiding traffic interruptions and supporting more plentiful traffics, and improving user experience and supporting various types of measurements.

Specifically, according to one aspect of the present application, the first measurement gap configuration indicates measurement gaps comprised by the first measurement gap set within a configuration period, where each measurement gap comprised by the first measurement gap set has a same position in each configuration period.

Specifically, according to one aspect of the present application, the first measurement gap configuration indicates a first candidate measurement gap set; the first measurement gap set only comprises measurement gaps not conflicting with a first time window set in the first candidate measurement gap set; the first time window set comprises at least one time window, and any time window in the first time window set comprises at least one slot.

Specifically, according to one aspect of the present application, the first measurement gap set comprises a second measurement gap, the second measurement gap not belonging to the first candidate measurement gap set; the second measurement gap does not conflict with the first time window set in time domain, a first measurement gap being used to determine the second measurement gap; the first measurement gap belongs to the first candidate measurement gap set but does not belong to the first measurement gap set.

Specifically, according to one aspect of the present application, the first signaling comprises a second measurement gap configuration, the second measurement gap configuration indicating a second candidate measurement gap set; herein, the second measurement gap belongs to the second candidate measurement gap set; measurement gaps in the second candidate measurement gap set are activated only when measurement gaps in the first candidate measurement gap set conflict with the first time window set in time domain.

Specifically, according to one aspect of the present application, the first signaling comprises a first Discontinuous Reception (DRX) parameter set, the first DRX parameter set being for a first cell group and unrelated to broadcast multicast or sidelink communications; the first DRX parameter set comprises a configuration parameter of a first DRX timer; running of the first DRX timer is used to determine the first measurement gap set.

Specifically, according to one aspect of the present application, the first signaling comprises a third measurement gap configuration and a first measurement object, the first measurement object used for configuring a measurement; the first measurement object indicates a first reference signal resource; a measurement of the first reference signal resource is associated with both a measurement gap configured by the first measurement gap configuration and a measurement gap configured by a third measurement gap configuration; herein, the first measurement gap configuration and the third measurement gap configuration are used together to determine the first measurement gap set.

Specifically, according to one aspect of the present application, the first node is a terminal of Internet of Things (IoT).

Specifically, according to one aspect of the present application, the first node is a relay.

Specifically, according to one aspect of the present application, the first node is a U2N remote UE.

Specifically, according to one aspect of the present application, the first node is a vehicle-mounted terminal.

Specifically, according to one aspect of the present application, the first node is an aircraft.

Specifically, according to one aspect of the present application, the first node is a cellphone.

Specifically, according to one aspect of the present application, the first node is a communication terminal supporting multi-SIM communications.

The present application provides a method in a second node for wireless communications, comprising:
transmitting a first signaling, the first signaling comprising a first measurement gap configuration, the first measurement gap configuration comprising that frequencies corresponding to measurement gaps are configured as a first frequency set; the first measurement gap configuration being used to determine a first measurement gap set; the first measurement gap set comprising at least two measurement gaps;
herein, any transmission or reception of a receiver of the first signaling for a serving cell on the first frequency set within the first measurement gap set other than RRM measurement and PRS measurement is ignored; any two measurement gaps in the first measurement gap set are orthogonal and non-consecutive in time domain; candidates of a time interval between any two time-domain adjacent measurement gaps in the first measurement gap set include a first time interval and a second time interval, where the first time interval is unequal to the second time interval.

Specifically, according to one aspect of the present application, the first measurement gap configuration indicates measurement gaps comprised by the first measurement gap set within a configuration period, where each measurement gap comprised by the first measurement gap set has a same position in each configuration period.

Specifically, according to one aspect of the present application, the first measurement gap configuration indicates a first candidate measurement gap set; the first measurement gap set only comprises measurement gaps not conflicting with a first time window set in the first candidate measurement gap set; the first time window set comprises at least one time window, and any time window in the first time window set comprises at least one slot.

Specifically, according to one aspect of the present application, the first measurement gap set comprises a second measurement gap, the second measurement gap not belonging to the first candidate measurement gap set; the second measurement gap does not conflict with the first time window set in time domain, a first measurement gap being used to determine the second measurement gap; the first measurement gap belongs to the first candidate measurement gap set but does not belong to the first measurement gap set.

Specifically, according to one aspect of the present application, the first signaling comprises a second measurement gap configuration, the second measurement gap configuration indicating a second candidate measurement gap set; herein, the second measurement gap belongs to the second candidate measurement gap set; measurement gaps in the second candidate measurement gap set are activated only when measurement gaps in the first candidate measurement gap set conflict with the first time window set in time domain.

Specifically, according to one aspect of the present application, the first signaling comprises a first Discontinuous Reception (DRX) parameter set, the first DRX parameter set being for a first cell group and unrelated to broadcast multicast or sidelink communications; the first DRX parameter set comprises a configuration parameter of a first DRX timer; running of the first DRX timer is used to determine the first measurement gap set.

Specifically, according to one aspect of the present application, the first signaling comprises a third measurement gap configuration and a first measurement object, the first measurement object used for configuring a measurement; the first measurement object indicates a first reference signal resource; a measurement of the first reference signal resource is associated with both a measurement gap configured by the first measurement gap configuration and a measurement gap configured by a third measurement gap configuration; herein, the first measurement gap configuration and the third measurement gap configuration are used together to determine the first measurement gap set.

Specifically, according to one aspect of the present application, the second node is a terminal of Internet of Things (IoT).

Specifically, according to one aspect of the present application, the second node is a satellite.

Specifically, according to one aspect of the present application, the second node is a relay.

Specifically, according to one aspect of the present application, the second node is a vehicle-mounted terminal.

Specifically, according to one aspect of the present application, the second node is an aircraft.

Specifically, according to one aspect of the present application, the second node is a base station.

Specifically, according to one aspect of the present application, the second node is a cell or cell group.

Specifically, according to one aspect of the present application, the second node is a gateway.

Specifically, according to one aspect of the present application, the second node is an access-point.

The present application provides a first node for wireless communications, comprising:
a first receiver, receiving a first signaling, the first signaling comprising a first measurement gap configuration, the first measurement gap configuration comprising that frequencies corresponding to measurement gaps are configured as a first frequency set;
the first receiver, determining a first measurement gap set according to the first measurement gap configuration; the first measurement gap set comprising at least two measurement gaps;
herein, any transmission or reception for a serving cell on the first frequency set within the first measurement gap set other than radio resource management (RRM) measurement and Positioning Reference Signal (PRS) measurement is ignored; any two measurement gaps in the first measurement gap set are orthogonal and non-consecutive in time domain; candidates of a time interval between any two time-domain adjacent measurement gaps in the first measurement gap set include a first time interval and a second time interval, where the first time interval is unequal to the second time interval.

The present application provides a second node for wireless communications, comprising:
a second transmitter, transmitting a first signaling, the first signaling comprising a first measurement gap configuration, the first measurement gap configuration comprising that frequencies corresponding to measurement gaps are configured as a first frequency set; the first measurement gap configuration being used to determine a first measurement gap set; the first measurement gap set comprising at least two measurement gaps;
herein, any transmission or reception of a receiver of the first signaling for a serving cell on the first frequency set within the first measurement gap set other than RRM measurement and PRS measurement is ignored; any two measurement gaps in the first measurement gap set are orthogonal and non-consecutive in time domain; candidates of a time interval between any two time-domain adjacent measurement gaps in the first measurement gap set include a first time interval and a second time interval, where the first time interval is unequal to the second time interval.

In one embodiment, compared with the prior art, the present application is advantageous in the following aspects:

Providing better support to XR traffics to ensure the quality of XR traffics as well as preventing the XR traffics from being interrupted during reception or transmission.

Supporting inter-frequency or other RAT network measurements amidst reception of XR traffics.

Supporting the communication quality of traffics with non-positive number of periods.

Supporting the communication quality of aperiodic traffics and aperiodic DRX configurations, for avoidance of unnecessary conflicts.

Providing more flexible configuration of measurement gaps.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of receiving a first signaling and determining a first measurement gap set according to a first measurement gap configuration according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a schematic diagram of measurement gaps according to one embodiment of the present application.

FIG. 7 illustrates a schematic diagram of measurement gaps according to one embodiment of the present application.

FIG. 8 illustrates a schematic diagram of a first measurement gap indicating measurement gaps comprised by a first measurement gap set in a configuration period according to one embodiment of the present application.

FIG. 9 illustrates a schematic diagram of a first measurement gap configuration indicating a first candidate measurement gap set according to one embodiment of the present application.

FIG. 10 illustrates a schematic diagram of a first measurement gap being used to determine a second measurement gap according to one embodiment of the present application.

FIG. 11 illustrates a schematic diagram of a second measurement gap configuration being used to indicate a second candidate measurement gap set according to one embodiment of the present application.

FIG. 12 illustrates a schematic diagram of the running of a first DRX timer being used to determine a first measurement gap set according to one embodiment of the present application.

FIG. 13 illustrates a schematic diagram of a first measurement gap configuration and a third measurement gap configuration being used together to determine a first measurement gap set according to one embodiment of the present application.

FIG. 14 illustrates a structure block diagram of a processing device in a first node according to one embodiment of the present application.

FIG. 15 illustrates a structure block diagram of a processing device in a second node according to one embodiment of the present application.

FIG. 16 illustrates a structure block diagram of a processing device in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of receiving a first signaling and determining a first measurement gap set according to a first measurement gap configuration according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives a first signaling in step 101, and determines a first measurement gap set according to a first measurement gap configuration in step 102;
herein, the first signaling comprises a first measurement gap configuration, the first measurement gap configuration comprising that frequencies corresponding to measurement gaps are configured as a first frequency set; and the first measurement gap set comprising at least two measurement gaps; any transmission or reception for a serving cell on the first frequency set within the first measurement gap set other than radio resource management (RRM) measurement and Positioning Reference Signal (PRS) measurement is ignored; any two measurement gaps in the first measurement gap set are orthogonal and non-consecutive in time domain; candidates of a time interval between any two time-domain adjacent measurement gaps in the first measurement gap set include a first time interval and a second time interval, where the first time interval is unequal to the second time interval.

In one embodiment, the first node is a User Equipment (UE).

In one embodiment, the first node is in an RRC connected state.

In one embodiment, the first node does not support multi-connectivity.

In one embodiment, the first node supports multi-connectivity.

In one embodiment, the first node has only one receiver.

In one embodiment, the first node has only one transmitter.

In one embodiment, a serving cell refers to a cell that the UE is camped on. Performing cell search includes that the UE searches for a suitable cell for a selected Public Land Mobile Network (PLMN) or Stand-alone Non-Public Network (SNPN), selects the suitable cell to provide available services, and monitors a control channel of the suitable cell, where the whole procedure is defined to be camped on the cell; in other words, relative to this UE, the cell being camped on is seen as a serving cell of the UE. Being camped on a cell in either RRC Idle state or RRC Inactive state is advantageous in the following aspects: enabling the UE to receive system information from a PLMN or an SNPN; after registration, if a UE hopes to establish an RRC connection or resume a suspended RRC connection, the UE can perform an initial access on a control channel of the camped cell to achieve such purpose; the network can page the UE; so that the UE can receive notifications from the Earthquake and Tsunami Warning System (ETWS) and the Commercial Mobile Alert System (CMAS).

In one embodiment, for a UE in RRC connected state without being configured with carrier aggregation/dual connectivity (CA/DC), there is only one serving cell that comprises a primary cell. For a UE in RRC connected state that is configured with carrier aggregation/dual connectivity (CA/DC), a serving cell is used for indicating a cell set comprising a Special Cell (SpCell) and all secondary cells. A Primary Cell is a cell in a Master Cell Group (MCG), i.e., an MCG cell, working on the primary frequency, and the UE performs an initial connection establishment procedure or initiates a connection re-establishment on the Primary Cell. For dual connectivity (DC) operation, a special cell refers to a Primary Cell (PCell) in an MCG or a Primary SCG Cell (PSCell) in a Secondary Cell Group (SCG); otherwise, the special cell refers to a PCell.

In one embodiment, working frequency of a Secondary Cell (SCell) is secondary frequency.

In one embodiment, separate contents in information elements (IEs) are called fields.

In one embodiment, Multi-Radio Dual Connectivity (MR-DC) refers to dual connectivity with an E-UTRA node and an NR node, or with two NR nodes.

In one embodiment, in MR-DC, a radio access node providing a control plane connection to the core network is a master node, where the master node can be a master eNB, a master ng-eNB or a master gNB.

In one embodiment, an MCG refers to a group of serving cells associated with a master node in MR-DC, including a SpCell, and optionally, one or multiple SCells.

In one embodiment, a PCell is a SpCell of an MCG.

In one embodiment, a PSCell is a SpCell of an SCG.

In one embodiment, in MR-DC, a radio access node not providing a control plane connection to the core network but providing extra resources for the UE is a secondary node. The secondary node can be an en-gNB, a secondary ng-eNB or a secondary gNB.

In one embodiment, in MR-DC, a group of serving cells associated with a secondary node is a secondary cell group (SCG), including a SpCell and, optionally, one or multiple SCells.

In one embodiment, the first signaling is an RRC signaling.

In one embodiment, the first signaling comprises an RRC signaling.

In one embodiment, the first signaling is for a specific UE.

In one embodiment, the first signaling is transmitted in a unicast way.

In one embodiment, the first signaling is transmitted on an SRB1.

In one embodiment, the first signaling is a RRCReconfiguration.

In one embodiment, the first signaling is or comprises a MeasConfig.

In one embodiment, the first signaling is or comprises a measGapConfig.

In one embodiment, the first measurement gap configuration is a field in the first signaling.

In one embodiment, the first signaling comprises a GapConfig.

In one embodiment, the first signaling comprises a gapFR2.

In one embodiment, the first signaling comprises a gapFR1.

In one embodiment, the first signaling comprises a gapUE.

In one embodiment, the first signaling comprises a gapUE.

In one embodiment, the first signaling is transmitted by a PCell or a Master Cell Group (MCG) of the first node.

In one embodiment, the first measurement gap configuration is or includes a MeasGapConfig.

In one embodiment, the first measurement gap configuration is or includes a GapConfig in a MeasGapConfig.

In one embodiment, an identity of the first measurement gap configuration is a first measurement gap configuration ID.

In one embodiment, a type of measurement gap(s) configured by the first measurement gap configuration is perUE or perFR1 or perFR2.

In one embodiment, a type of measurement gap(s) configured by the first measurement gap configuration is one of perUE or per frequency range 1 (perFR1) or per frequency range 2 (perFR2).

In one embodiment, the first measurement gap configuration comprises that the frequencies corresponding to measurement gaps are frequencies on which measurement gaps configured by the first measurement gap configuration are used for measurements.

In one embodiment, the first frequency set is frequencies on which measurement gaps configured by the first measurement gap configured are used for measurements.

In one embodiment, the first node performs measurements of frequencies in the first frequency set on measurement gaps configured by the first measurement gap configuration.

In one embodiment, the first node performs measurements of frequencies in the first frequency set on measurement gaps in the first measurement gap set.

In one embodiment, the first frequency set comprises frequency/frequencies in FR1.

In one embodiment, the first frequency set comprises frequency/frequencies in FR2.

In one embodiment, the first frequency set comprises frequency/frequencies in FR1 and FR2.

In one embodiment, a type of measurement gaps comprised by the first measurement gap configuration is used for indicating the first frequency set.

In one embodiment, the sentence of determining a first measurement gap set according to the first measurement gap configuration comprises: setting up the first measurement gap set according to the first measurement gap configuration.

In one embodiment, the sentence of determining a first measurement gap set according to the first measurement gap configuration comprises: the first measurement gap set belonging to measurement gaps indicated by the first measurement gap configuration.

In one embodiment, the sentence of determining a first measurement gap set according to the first measurement gap configuration comprises: the first measurement gap configuration indicating a configuration parameter of each measurement gap in the first measurement gap set.

In one embodiment, the sentence of determining a first measurement gap set according to the first measurement gap configuration comprises: the first measurement gap configuration indicating each measurement gap in the first measurement gap set.

In one embodiment, the sentence of determining a first measurement gap set according to the first measurement gap configuration comprises: the first measurement gap configuration indicating the first measurement gap set.

In one embodiment, the sentence of determining a first measurement gap set according to the first measurement gap configuration comprises: the first measurement gap configuration indicating a first candidate measurement gap set, the first candidate measurement gap set used for determining the first measurement gap set.

In one embodiment, the sentence of determining a first measurement gap set according to the first measurement gap configuration comprises: the first measurement gap configuration indicating a first candidate measurement gap set, where the first measurement gap set belongs to the first candidate measurement gap set.

In one embodiment, the first measurement gap set comprises at least 3 measurement gaps.

In one embodiment, before reception of any reconfiguration or release command of measurement gaps, the first measurement gap set comprises uncountable measurement gaps.

In one embodiment, before reception of any reconfiguration or release command of measurement gaps, the first measurement gap set comprises infinite measurement gaps.

In one embodiment, any element in the first measurement gap set is a measurement gap.

In one embodiment, the first node only performs RRM measurement and/or PRS measurement within the first measurement gap set.

In one embodiment, the RRM measurement includes a channel quality measurement.

In one embodiment, the RRM measurement includes measuring a Reference Signal Received Power (RSRP).

In one embodiment, the RRM measurement includes measuring a Reference Signal Received Quality (RSRQ).

In one embodiment, the RRM measurement includes measuring a Received Signal Strength Indication (RSSI).

In one embodiment, the RRM measurement includes measuring an SS-RSRP.

In one embodiment, the RRM measurement includes a measurement used for radio link monitoring.

In one embodiment, the RRM measurement includes a beam failure detection.

In one embodiment, the RRM measurement includes a measurement of TRP.

In one embodiment, the RRM measurement includes a measurement of an SSB.

In one embodiment, the RRM measurement includes a measurement of a CSI-RS.

In one embodiment, the RRM measurement includes a measurement used for channel quality evaluation.

In one embodiment, the PRS measurement is a measurement of PRS resources.

In one embodiment, the PRS measurement includes measuring an RSRP of PRS.

In one embodiment, the PRS measurement is a measurement used for positioning.

In one embodiment, the sentence that any transmission or reception for a serving cell on the first frequency set within the first measurement gap set other than RRM measurement and PRS measurement is ignored means that: the first node is not required to receive or transmit any signal other than RRM measurement and PRS measurement for a serving cell on the first frequency set within the first measurement gap set.

In one embodiment, the sentence that any transmission or reception for a serving cell on the first frequency set within the first measurement gap set other than RRM measurement and PRS measurement is ignored means that: the first node can choose not to transmit for a serving cell on the first frequency set within the first measurement gap set.

In one embodiment, the sentence that any transmission or reception for a serving cell on the first frequency set within the first measurement gap set other than RRM measurement and PRS measurement is ignored means that: the first node can choose not to receive traffics for a serving cell on the first frequency set within the first measurement gap set.

In one embodiment, the sentence that any transmission or reception for a serving cell on the first frequency set within the first measurement gap set other than RRM measurement and PRS measurement is ignored means that: the first node can choose not to receive any signal other than that for RRM measurement or PRS measurement for a serving cell on the first frequency set within the first measurement gap set.

In one embodiment, the sentence that any transmission or reception for a serving cell on the first frequency set within the first measurement gap set other than RRM measurement and PRS measurement is ignored means that: the first node only performs RRM measurement and/or PRS measurement for a serving cell on the first frequency set within the first measurement gap set.

In one embodiment, the sentence that any transmission or reception for a serving cell on the first frequency set within the first measurement gap set other than RRM measurement and PRS measurement is ignored means that: any transmission of Hybrid Automatic Repeat Request (HARQ) feedback, scheduling request (SR) or channel state information (CSI) is not performed for a serving cell on the first frequency set within the first measurement gap set.

In one embodiment, the sentence that any transmission or reception for a serving cell on the first frequency set within the first measurement gap set other than RRM measurement and PRS measurement is ignored means that: a sounding reference signal (SRS) is not reported for a serving cell on the first frequency set within the first measurement gap set.

In one embodiment, the sentence that any transmission or reception for a serving cell on the first frequency set within the first measurement gap set other than RRM measurement and PRS measurement is ignored means that: any payload other than a Msg3 or a MSGA is not transmitted on an uplink-shared channel (UL-SCH) for a serving cell on the first frequency set within the first measurement gap set.

In one embodiment, the sentence that any transmission or reception for a serving cell on the first frequency set within the first measurement gap set other than RRM measurement and PRS measurement is ignored means that: a physical downlink Control channel (PDCCH) is not monitored for a serving cell on the first frequency set within the first measurement gap set while a ra-ResponseWindow or a ra-ContentionResolutionTimer or a msgB-Response Window is not running.

In one embodiment, the sentence that any transmission or reception for a serving cell on the first frequency set within the first measurement gap set other than RRM measurement and PRS measurement is ignored means that: a downlink-shared channel (DL-SCH) is not received for a serving cell on the first frequency set within the first measurement gap set while a ra-Response Window or a ra-ContentionResolutionTimer or a msgB-ResponseWindow is not running.

In one embodiment, the first measurement gap set only comprises activated measurement gaps.

In one embodiment, the first measurement gap set only comprises measurement gaps supporting measurements.

In one embodiment, the first measurement gap set only comprises measurement gaps supporting inter-frequency measurements.

In one embodiment, the first measurement gap set only comprises measurement gaps supporting inter-RAT measurements.

In one embodiment, measurement gaps in the first measurement gap set can be sorted in an order in time.

In one embodiment, any two measurement gaps in the first measurement gap set are non-overlapping.

In one embodiment, any two measurement gaps in the first measurement gap set are non-consecutive.

In one embodiment, a time interval between any two measurement gaps in the first measurement gap set is greater than X slot(s), where X is a positive integer.

In one embodiment, a time interval between any two measurement gaps in the first measurement gap set is greater than M millisecond(s), where M is a positive integer.

In one embodiment, the first measurement gap configuration is used to determine one of the first time interval or the second time interval.

In one embodiment, the first measurement gap configuration comprises a period of measurement gaps, where one of the first time interval or the second time interval is equal to the period of measurement gaps comprised by the first measurement gap configuration.

In one embodiment, a mgrp field comprised by the first measurement gap configuration is used for indicating a period of measurement gaps.

In one embodiment, the second time interval is N times the length of the first time interval, where N is a positive integer greater than 1.

In one embodiment, the second time interval is longer than the first time interval, but is smaller than 2 times the length of the first time interval.

In one embodiment, a length of the configuration period is a lowest common multiple of the first time interval and the second time interval.

In one embodiment, a first node is not required to perform any transmission or reception other than RRM measurement and PRS measurement for a serving cell on the first frequency set within the first measurement gap set.

In one embodiment, a first node itself determines whether to perform any transmission or reception other than RRM measurement and PRS measurement for a serving cell on the first frequency set within the first measurement gap set.

In one embodiment, a first node itself does not perform any transmission or reception other than RRM measurement and PRS measurement for a serving cell on the first frequency set within the first measurement gap set.

In one embodiment, the first node determines by itself whether to perform any periodic uplink transmission or periodic downlink reception (other than RRM measurement and PRS measurement) configured for a serving cell on the first frequency set within the first measurement gap set.

In one embodiment, the first node determines by itself whether to perform any uplink transmission or downlink reception dynamically scheduled for a serving cell on the first frequency set within the first measurement gap set.

In one embodiment, the first node determines by itself whether to perform any period transmission or reception configured (other than RRM measurement and PRS measurement) for a serving cell on the first frequency set within the first measurement gap set.

In one embodiment, all measurement gaps in the first measurement gap set are of equal lengths.

In one embodiment, the first measurement gap set comprises at least two measurement gaps of unequal lengths.

In one embodiment, the first measurement gap configuration comprises: configuring lengths of measurement gaps as a first length.

In one embodiment, candidate values of the first length include at least one of 1.5 ms, 3 ms, 3.5 ms, 4 ms, 5.5 ms, 6 ms, 10 ms, or 20 ms.

In one embodiment, the first measurement gap configuration comprises: configuring an offset of measurement gaps as a first offset.

In one embodiment, the first measurement gap configuration comprises: configuring a period of measurement gaps as a first period.

In one embodiment, any measurement gap in the first measurement gap set is an activated measurement gap.

In one embodiment, candidate values of a period of measurement gaps comprised by the first measurement gap configuration include 20 ms, 40 ms, 80 ms and 160 ms.

In one embodiment, candidate values of a period of measurement gaps comprised by the first measurement gap configuration include value(s) other than 20 ms, 40 ms, 80 ms and 160 ms.

In one embodiment, a candidate value of a period of measurement gaps comprised by the first measurement gap configuration includes 50 ms.

In one embodiment, a candidate value of a period of measurement gaps comprised by the first measurement gap configuration includes 25 ms.

In one embodiment, a candidate value of a period of measurement gaps comprised by the first measurement gap configuration includes 30 ms.

In one embodiment, the first measurement gap configuration does not comprise the period of measurement gaps.

In one embodiment, the configuration period and the period of the measurement gaps do not co-exist.

In one embodiment, the first measurement gap configuration indicates each measurement gap comprised by the first measurement gap set within a configuration period.

In one embodiment, each measurement gap comprised by the first measurement gap set has a same position in each configuration period.

In one embodiment, the sentence that the first measurement gap set only comprises measurement gaps not conflicting with a first time window set in the first candidate measurement gap set means that: the first measurement gap set only comprises measurement gaps in the first candidate measurement gap set that are not conflicting with a first time window set.

In one embodiment, the sentence that the first measurement gap set only comprises measurement gaps not conflicting with a first time window set in the first candidate measurement gap set means that: the first measurement gap set does not comprise measurement gaps in the first candidate measurement gap set that are conflicting with a first time window set.

In one embodiment, the sentence that the first measurement gap set only comprises measurement gaps not conflicting with a first time window set in the first candidate measurement gap set means that: the first measurement gap set does not comprise measurement gaps in the first candidate measurement gap set that are conflicting with a first time window set.

In one embodiment, the first measurement gap set belongs to the first candidate measurement gap set.

In one embodiment, the first measurement gap set comprises at least one measurement gap that does not belong to the first candidate measurement gap set.

In one embodiment, the meaning of the phrase of not conflicting with a first time window set includes: not conflicting with any time window in the first time window set.

In one embodiment, the meaning of the phrase of not conflicting with a first time window set includes: not overlapping with any time window in the first time window set.

In one embodiment, the meaning of the phrase of not conflicting with a first time window set includes: partially overlapping with any time window in the first time window set.

In one embodiment, the meaning of the phrase of not conflicting with a first time window set includes: totally overlapping with any time window in the first time window set.

In one embodiment, the meaning of the phrase of not conflicting with a first time window set includes: belonging to any time window in the first time window set.

In one embodiment, the meaning of the phrase of not conflicting with a first time window set includes: not overlapping with any time window in the first time window set, nor overlapping with any time within n1 ms before any time window in the first time window set.

In one embodiment, n1 is a positive integer.

In one embodiment, n1 is 4.

In one embodiment, the meaning of the phrase of not conflicting with a first time window set includes: not overlapping with any time window in the first time window set, nor overlapping with any time within n2 ms after any time window in the first time window set.

In one embodiment, n2 is a positive integer.

In one embodiment, n2 is 4.

In one embodiment, candidates for a time interval between any two adjacent time windows comprised by the first time window set include at least 2 candidate values.

In one embodiment, a time interval between any two adjacent time windows comprised by the first time window set is a non-integer.

In one embodiment, a time interval between any two adjacent time windows comprised by the first time window set is an approximate value of a non-integer.

In one embodiment, the first time window set is used for transmission of XR services.

In one embodiment, the first time window set is network-configured.

In one embodiment, the first time window set is system-configured.

In one embodiment, the first time window set is determined by the first node itself.

In one embodiment, the first time window set is configurable.

In one embodiment, the first time window set is DRX-related.

In one embodiment, the first time window set is related to QoS information of a service.

In one embodiment, the first time window set is related to a transmission period of a service.

In one embodiment, the first time window set is related to a transmission template of a service.

In one embodiment, the slot comprises 1 millisecond.

In one embodiment, the slot comprises 1 slot.

In one embodiment, the slot comprises 1 subframe.

In one embodiment, the slot comprises 1 frame.

In one embodiment, the slot is related to the measurement gap.

In one embodiment, the slot comprises 0.5 millisecond.

In one embodiment, the slot comprises 1 symbol.

In one embodiment, the slot comprises 1 time unit.

In one embodiment, the first signaling is used to determine the first time window set.

In one embodiment, the first signaling is used to determine at least one time window in the first time window set.

In one embodiment, the first signaling is used to indicate a start of at least one time window in the first time window set.

In one embodiment, the first measurement gap set is a subset of the first candidate measurement gap set.

In one embodiment, when any measurement gap in the first candidate measurement gap set conflicts with the first time window set in time domain, the any measurement gap in the first candidate measurement gap set is deactivated.

In one embodiment, the first signaling comprises a first DRX configuration set, the first DRX configuration set used for determining the first time window set.

In one embodiment, the first measurement gap is any measurement gap in the first candidate measurement gap set.

In one embodiment, the first measurement gap is any measurement gap conflicting with the first time window set in the first candidate measurement gap set.

In one embodiment, the second measurement gap is determined by the first node itself.

In one embodiment, the second measurement gap is determined by the first node according to network configuration.

In one embodiment, the second measurement gap is indicated by the first signaling.

In one embodiment, the first measurement gap configuration indicates a first candidate measurement gap set.

In one embodiment, the first measurement gap set only comprises measurement gaps not conflicting with a first time window set in the first candidate measurement gap set.

In one embodiment, the first time window set comprises at least one time window.

In one embodiment, any time window in the first time window set comprises at least one slot.

In one embodiment, the first signaling comprises a second measurement gap configuration, the second measurement gap configuration indicating a second candidate measurement gap set.

In one embodiment, the second measurement gap belongs to the second candidate measurement gap set.

In one embodiment, measurement gaps in the second candidate measurement gap set are activated only when measurement gaps in the first candidate measurement gap set conflict with the first time window set in time domain.

In one embodiment, the second measurement gap configuration is a GapConfig field in the first signaling.

In one embodiment, the first measurement gap configuration and the second measurement gap configuration are respectively two fields in the first signaling.

In one embodiment, the first measurement gap configuration and the second measurement gap configuration are respectively two Information Elements (IEs) of the same name comprised in the first signaling.

In one embodiment, the first measurement gap configuration and the second measurement gap configuration are respectively two Information Elements (IEs) whose name includes GapConfig comprised in the first signaling.

In one embodiment, the sentence that measurement gaps in the second candidate measurement gap set are activated only when measurement gaps in the first candidate measurement gap set conflict with the first time window set in time domain means that: an initial status of each measurement gap in the second candidate measurement gap set is deactivated.

In one embodiment, the sentence that measurement gaps in the second candidate measurement gap set are activated only when measurement gaps in the first candidate measurement gap set conflict with the first time window set in time domain means that: when a measurement gap in the first candidate measurement gap set conflicts with the first time window set, a measurement gap in the second candidate measurement gap set is activated.

In one embodiment, the sentence that measurement gaps in the second candidate measurement gap set are activated only when measurement gaps in the first candidate measurement gap set conflict with the first time window set in time domain means that: the measurement gap being activated in the second candidate measurement gap set is a measurement gap adjacent to a measurement gap in the first candidate measurement gap set that conflicts with the first time window set in time domain.

In one embodiment, the sentence that measurement gaps in the second candidate measurement gap set are activated only when measurement gaps in the first candidate measurement gap set conflict with the first time window set in time domain means that: the measurement gap being activated in the second candidate measurement gap set is a first measurement gap that is later than a measurement gap in the first candidate measurement gap set that conflicts with the first time window set in time domain and does not conflict with the first time window set.

In one embodiment, the sentence that measurement gaps in the second candidate measurement gap set are activated only when measurement gaps in the first candidate measurement gap set conflict with the first time window set in time domain means that: the measurement gap being activated in the second candidate measurement gap set is a last measurement gap that is earlier than a measurement gap in the first candidate measurement gap set that conflicts with the first time window set in time domain and does not conflict with the first time window set.

In one embodiment, a priority of measurement gaps comprised by the first measurement gap configuration is higher than that comprised by the second measurement gap configuration.

In one embodiment, measurement gaps in the second candidate measurement gap set are of an equal length to measurement gaps in the first candidate measurement gap set.

In one embodiment, measurement gaps in the second candidate measurement gap set are of equal lengths.

In one embodiment, measurement gaps in the first candidate measurement gap set are of equal lengths.

In one embodiment, the first candidate measurement gap set comprises at least 2 measurement gaps of unequal lengths.

In one embodiment, the first signaling can comprise multiple RRC messages.

In one embodiment, the first signaling can comprise multiple sub-signalings.

In one embodiment, the first signaling is an RRC message.

In one embodiment, the first signaling comprises a first Discontinuous Reception (DRX) parameter set.

In one embodiment, the first DRX parameter set is for a first cell group and unrelated to broadcast multicast or sidelink communications.

In one embodiment, the first DRX parameter set comprises a configuration parameter of a first DRX timer; running of the first DRX timer is used to determine the first measurement gap set.

In one embodiment, the first DRX parameter set comprises at least one DRX parameter.

In one embodiment, the first DRX parameter set comprises multiple DRX groups.

In one subembodiment, at least one serving cell of the first node belongs to multiple DRX groups comprised by the first DRX parameter set.

In one embodiment, the first DRX parameter set comprises a DRX period.

In one embodiment, the first DRX parameter set comprises an expiration value of a DRX timer.

In one embodiment, the first DRX parameter set comprises multiple DRX configurations.

In one embodiment, the first cell group is an MCG of the first node.

In one embodiment, the first cell group is an SCG of the first node.

In one embodiment, the phrase of being unrelated to broadcast multicast or sidelink communications means that: the first DRX parameter set is not for a G-RNTI.

In one embodiment, the phrase of being unrelated to broadcast multicast or sidelink communications means that: the first DRX parameter set is not for point to multipoint (PTM).

In one embodiment, the phrase of being unrelated to broadcast multicast or sidelink communications means that: a name of any parameter in the first DRX parameter set does not include PTM.

In one embodiment, the phrase of being unrelated to broadcast multicast or sidelink communications means that: the first DRX parameter set is not used for DRX in sidelink communications.

In one embodiment, the phrase of being unrelated to broadcast multicast or sidelink communications means that: a name of any parameter in the first DRX parameter set does not include sl.

In one embodiment, the first DRX timer is an onduration timer for DRX.

In one embodiment, the first DRX timer is a drx-onDurationTimer.

In one embodiment, the first DRX parameter set comprises an expiration value of the first DRX timer.

In one embodiment, each of multiple DRX configurations of the first DRX parameter set respectively configures an instance of the first DRX timer.

In one embodiment, each of multiple DRX configurations of the first DRX parameter set respectively configures a drx-onDurationTimer.

In one embodiment, the first signaling comprises a third measurement gap configuration and a first measurement object, the first measurement object used for configuring a measurement.

In one embodiment, the first measurement object indicates a first reference signal resource.

In one embodiment, a measurement of the first reference signal resource is associated with both a measurement gap configured by the first measurement gap configuration and a measurement gap configured by a third measurement gap configuration;

In one embodiment, the first measurement gap configuration and the third measurement gap configuration are used together to determine the first measurement gap set.

In one embodiment, the third measurement gap configuration is a GapConfig field in the first signaling.

In one embodiment, the first measurement gap configuration is a GapConfig IE in the first signaling.

In one embodiment, the second measurement gap configuration is a GapConfig IE in the first signaling.

In one embodiment, the third measurement gap configuration is a GapConfig IE in the first signaling.

In one embodiment, the first measurement gap configuration and the third measurement gap configuration are respectively two fields in the first signaling.

In one embodiment, the first measurement gap configuration and the third measurement gap configuration are respectively two Information Elements (IEs) of the same name comprised in the first signaling.

In one embodiment, the first measurement gap configuration and the third measurement gap configuration are respectively two Information Elements (IEs) whose name includes GapConfig comprised in the first signaling.

In one embodiment, a MeasConfig comprised by the first signaling indicates the first measurement object.

In one embodiment, the first measurement object is a MeasObjectNR.

In one embodiment, the first measurement object is used for configuring frequency for measurements.

In one embodiment, the first measurement object is used for configuring a reference signal resource for measurements.

In one embodiment, the first measurement object is used for configuring a cell corresponding to measurements.

In one embodiment, the first reference signal resource comprises an SSB or an SSB resource.

In one embodiment, a synchronization signal block (SSB) refers to a synchronization signal (SS)/physical broadcast channel (PBCH) block.

In one embodiment, the first reference signal resource comprises a channel state information reference signal (CSI-RS) or a CSI-RS resource.

In one embodiment, the first signaling indicates that a measurement of the first reference signal resource is associated with both a measurement gap configured by the first measurement gap configuration and a measurement gap configured by a third measurement gap configuration.

In one embodiment, an associatedMeasGap field in the first signaling indicates that a measurement of the first reference signal resource is associated with measurement gaps configured by the first measurement gap configuration.

In one embodiment, an associatedMeasGap field in the first signaling indicates that a measurement of the first reference signal resource is associated with measurement gaps configured by the third measurement gap configuration.

In one embodiment, an associatedMeasGapSSB field in the first signaling indicates that a measurement of the first reference signal resource is associated with measurement gaps configured by the first measurement gap configuration.

In one embodiment, an associatedMeasGapCSIRS field in the first signaling indicates that a measurement of the first reference signal resource is associated with measurement gaps configured by the first measurement gap configuration.

In one embodiment, an associatedMeasGapSSB field in the first signaling indicates that a measurement of the first reference signal resource is associated with measurement gaps configured by the third measurement gap configuration.

In one embodiment, an associatedMeasGapCSIRS field in the first signaling indicates that a measurement of the first reference signal resource is associated with measurement gaps configured by the third measurement gap configuration.

In one embodiment, the first time window set is related to transmission of a first semi-persistence scheduling (SPS).

In one embodiment, the first time window set corresponds to transmission resources in time domain for a first SPS.

In one embodiment, the first time window set is related to transmission of a first configured grant (CG).

In one embodiment, the first time window set corresponds to transmission resources in time domain for a first CG.

In one embodiment, the first time window set corresponds to time-domain resources of a search space.

In one embodiment, the action of determining a first measurement gap set according to the first measurement gap configuration is related to configuration of a first radio bearer (RB).

In one subembodiment, the first signaling indicates that a priority of the first RB is higher than measurement gaps.

In one subembodiment, the first signaling indicates that a priority of the first RB is higher than at least one measurement gap.

In one subembodiment, the first RB is used for transmitting XR traffics.

In one subembodiment, the first signaling indicates that a reception of the first RB can preempt measurement gaps.

In one embodiment, the first signaling indicates that communication on a first time window set is not influenced by measurement gaps.

In one embodiment, the first signaling indicates that communication on a first time window set is not influenced by measurement gaps configured by the first measurement gap configuration.

In one embodiment, the first signaling indicates a first time window set.

In one embodiment, the first signaling indicates that the first node ignores measurement gaps configured by the first measurement gap configuration on the first time window set.

In one embodiment, the first signaling indicates that the first node ignores measurement gaps on the first time window set.

In one embodiment, when the first signaling indicates that the first node shall ignore measurement gaps on the first time window set, the first measurement gap set is different from the first candidate measurement gap set; when the first signaling does not indicate that the first node shall ignore measurement gaps on the first time window set, the first measurement gap set is identical to the first candidate measurement gap set.

In one embodiment, the first time window set corresponds to a transmission time for first service.

In one embodiment, the first time window set corresponds to a transmission time for a first radio bearer.

In one embodiment, the first service is transmitted within the first time window set.

In one embodiment, the first service is transmitted within the first radio bearer.

In one embodiment, the first signaling indicates measurement gap(s) that can be deactivated or ignored in the first candidate measurement gap set.

In one embodiment, any time window in the first time window set corresponds to a time of running of a first DRX timer.

In one embodiment, any time window in the first time window set corresponds to an Active Time of MAC of the first node.

In one embodiment, any time window in the first time window set corresponds to an Active Time of the first cell group.

### Embodiment 2

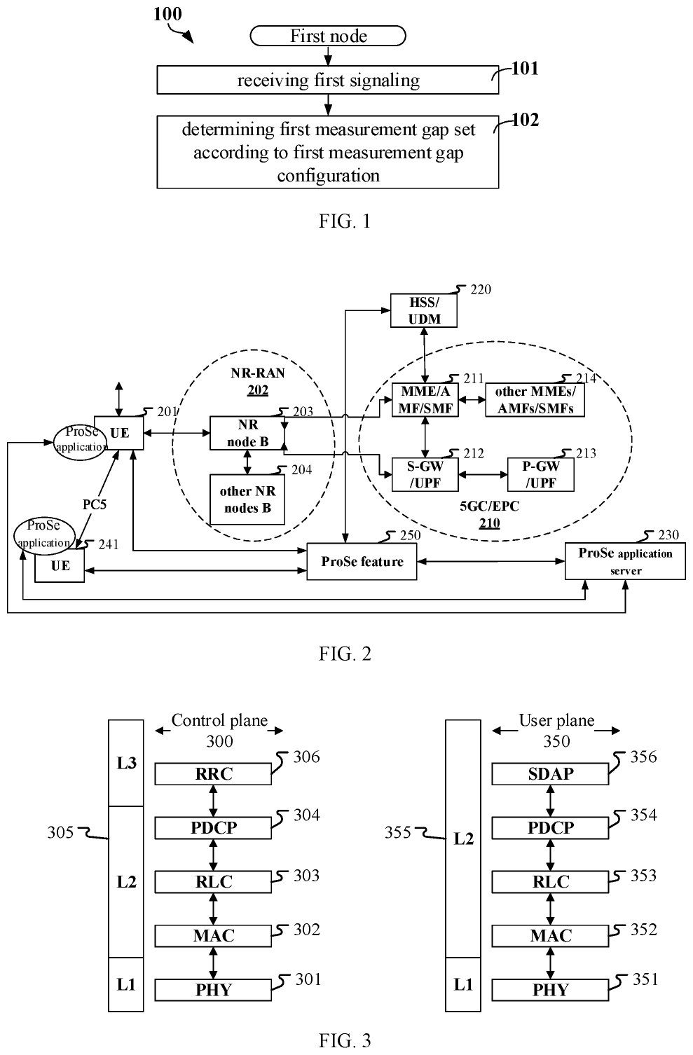

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called 5G System/Evolved Packet System (5GS/EPS) 200 or other appropriate terms. The 5GS/EPS 200 may comprise one or more UEs 201, an NG-RAN 202, a 5G-Core Network/Evolved Packet Core (5GC/EPC) 210, a Home Subscriber Server/Unified Data Management(HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected with the 5G-CN/EPC 210 via an S1/NG interface. The 5G-CN/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the first node in the present application is the UE 201.

In one embodiment, the second node in the present application is the gNB203.

In one embodiment, a radio link from the UE 201 to the NR Node B is an uplink.

In one embodiment, a radio link from the NR Node B to the UE 201 is a downlink.

In one embodiment, the UE 201 supports relay transmission.

In one embodiment, the UE 201 includes cellphone.

In one embodiment, the UE 201 is a means of transportation including automobile.

In one embodiment, the UE 201 supports multiple SIMS.

In one embodiment, the UE 201 supports sidelink transmission.

In one embodiment, the UE 201 supports MBS transmission.

In one embodiment, the UE 201 supports MBMS transmission.

In one embodiment, the gNB 203 is a MacroCellular base station.

In one embodiment, the gNB203 is a Micro Cell base station.

In one embodiment, the gNB 203 is a PicoCell base station.

In one embodiment, the gNB203 is a flight platform.

In one embodiment, the gNB203 is satellite equipment.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE, gNB or, satellite or aircraft in NTN) and a second node (gNB, UE, or satellite or aircraft in NTN), or between two UEs, is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first node between nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second node and the first node. The PC5 Signaling Protocol (PC5-S) sublayer307 is responsible for processing the signaling protocol at the PC5 interface. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first node may comprise several higher layers above the L2 355. Besides, the first node comprises a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC 306.

In one embodiment, the first measurement report in the present application is generated by the RRC306.

### Embodiment 4

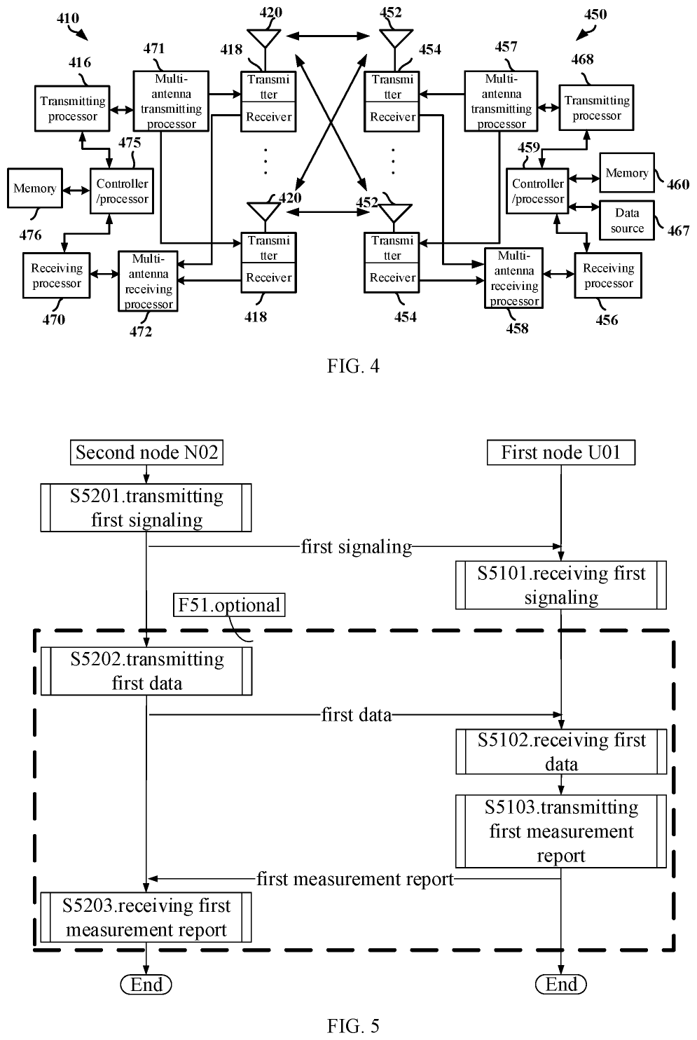

Embodiment 4 illustrates a schematic diagram of a first communication device and a second communication device according to one embodiment of the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, and optionally a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, and optionally a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer (Layer-2). In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of HARQ operation, a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts baseband multicarrier symbol streams which have gone through reception analog precoding/beamforming operations from time domain to frequency domain using FFT. In frequency domain, physical layer data signals and reference signals are de-multiplexed by the receiving processor 456, where the reference signals are used for channel estimation while data signals are processed in the multi-antenna receiving processor 458 by multi-antenna detection to recover any spatial stream targeting the first communication device 450. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory, the at least one memory comprises computer program codes; the at least one memory and the computer program codes are configured to be used in collaboration with the at least one processor. The first communication device 450 at least: receives a first signaling, the first signaling comprising a first measurement gap configuration, the first measurement gap configuration comprising that frequencies corresponding to measurement gaps are configured as a first frequency set; and determines a first measurement gap set according to the first measurement gap configuration; the first measurement gap set comprising at least two measurement gaps; herein, any transmission or reception for a serving cell on the first frequency set within the first measurement gap set other than RRM measurement and PRS measurement is ignored; any two measurement gaps in the first measurement gap set are orthogonal and non-consecutive in time domain; candidates of a time interval between any two time-domain adjacent measurement gaps in the first measurement gap set include a first time interval and a second time interval, where the first time interval is unequal to the second time interval.

In one embodiment, the first communication node 450 comprises a memory that stores a computer readable instruction program, the computer readable instruction program generates actions when executed by at least one processor, which include: receiving a first signaling, the first signaling comprising a first measurement gap configuration, the first measurement gap configuration comprising that frequencies corresponding to measurement gaps are configured as a first frequency set; and determining a first measurement gap set according to the first measurement gap configuration; the first measurement gap set comprising at least two measurement gaps; herein, any transmission or reception for a serving cell on the first frequency set within the first measurement gap set other than RRM measurement and PRS measurement is ignored; any two measurement gaps in the first measurement gap set are orthogonal and non-consecutive in time domain; candidates of a time interval between any two time-domain adjacent measurement gaps in the first measurement gap set include a first time interval and a second time interval, where the first time interval is unequal to the second time interval.

In one embodiment, the second communication device 410 comprises at least one processor and at least one memory, the at least one memory comprises computer program codes; the at least one memory and the computer program codes are configured to be used in collaboration with the at least one processor. The second communication device 410 at least: transmits a first signaling, the first signaling comprising a first measurement gap configuration, the first measurement gap configuration comprising that frequencies corresponding to measurement gaps are configured as a first frequency set; the first measurement gap configuration being used to determine a first measurement gap set; the first measurement gap set comprising at least two measurement gaps; herein, any transmission or reception of a receiver of the first signaling for a serving cell on the first frequency set within the first measurement gap set other than RRM measurement and PRS measurement is ignored; any two measurement gaps in the first measurement gap set are orthogonal and non-consecutive in time domain; candidates of a time interval between any two time-domain adjacent measurement gaps in the first measurement gap set include a first time interval and a second time interval, where the first time interval is unequal to the second time interval.

In one embodiment, the second communication device 410 comprises a memory that stores a computer readable instruction program, the computer readable instruction program generates actions when executed by at least one processor, which include: transmitting a first signaling, the first signaling comprising a first measurement gap configuration, the first measurement gap configuration comprising that frequencies corresponding to measurement gaps are configured as a first frequency set; the first measurement gap configuration being used to determine a first measurement gap set; the first measurement gap set comprising at least two measurement gaps; herein, any transmission or reception of a receiver of the first signaling for a serving cell on the first frequency set within the first measurement gap set other than RRM measurement and PRS measurement is ignored; any two measurement gaps in the first measurement gap set are orthogonal and non-consecutive in time domain; candidates of a time interval between any two time-domain adjacent measurement gaps in the first measurement gap set include a first time interval and a second time interval, where the first time interval is unequal to the second time interval.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a vehicle-mounted terminal.

In one embodiment, the first communication device 450 is a relay.

In one embodiment, the first communication device 450 is a satellite.

In one embodiment, the first communication device 450 is an aircraft.

In one embodiment, the second communication device 410 is a base station.

In one embodiment, the second communication device 410 is a relay.

In one embodiment, the second communication device 410 is a UE.

In one embodiment, the second communication device 410 is a satellite.

In one embodiment, the second communication device 410 is an aircraft.

In one embodiment, the receiver 454 (comprising the antenna 452), the receiving processor 456 and the controller/processor 459 are used for receiving the first signaling in the present application.

In one embodiment, the transmitter 454 (comprising the antenna 452), the transmitting processor 468 and the controller/processor 459 are used for transmitting the first measurement report in the present application.

In one embodiment, the transmitter 418 (comprising the antenna 420), the transmitting processor 416 and the controller/processor 475 are used for transmitting the first signaling in the present application.

In one embodiment, the receiver 418 (comprising the antenna 420), the receiving processor 470 and the controller/processor 475 are used for receiving the first measurement report in the present application.

### Embodiment 5

Embodiment 5 illustrates a flowchart of radio signal transmission according to one embodiment of the present application, as shown in FIG. 5. In FIG. 5, U01 corresponds to the first node in the present application, and N02 corresponds to the second node in the present application. It should be particularly noted that the sequence illustrated herein does not set any limit on the orders in which signals are transmitted and implementations in this present application. Herein, steps in F51 are optional.

The first node U01 receives a first signaling in step S5101; receives first data in step S5102; and transmits a first measurement report in step S5103.

The second node N02 transmits a first signaling in step S5201; transmits first data in step S5202; and receives a first measurement report in step S5203.

In Embodiment 5, the first signaling comprises a first measurement gap configuration, the first measurement gap configuration comprising that frequencies corresponding to measurement gaps are configured as a first frequency set; and the first measurement gap set comprising at least two measurement gaps; any transmission or reception for a serving cell on the first frequency set within the first measurement gap set other than RRM measurement and PRS measurement is ignored; any two measurement gaps in the first measurement gap set are orthogonal and non-consecutive in time domain; candidates of a time interval between any two time-domain adjacent measurement gaps in the first measurement gap set include a first time interval and a second time interval, where the first time interval is unequal to the second time interval.

In one embodiment, the first node U01 is a UE.

In one embodiment, the second node N02 is a network.

In one embodiment, the second node N02 is a base station.

In one embodiment, the second node N02 is a satellite.

In one embodiment, the second node N02 is a serving cell of the first node U01.

In one embodiment, the second node N02 is a Cell Group (CG) of the first node U01.

In one embodiment, the second node N02 is a PCell of the first node U01.

In one embodiment, the second node N02 is an MCG of the first node U01.

In one embodiment, the second node N02 is a SpCell of the first node U01.

In one embodiment, an interface via which the second node N02 is in communication with the first node U01 includes Uu.

In one embodiment, the first node U01 determines a first measurement gap set according to the first measurement gap configuration.

In one embodiment, the first signaling is transmitted before transmitting first service.

In one embodiment, the step S5101 is earlier than the step S5102.

In one embodiment, the first data is data of first service.

In one embodiment, the first data comprises at least one protocol data unit (PDU).

In one embodiment, the first data is transmitted by a downlink channel.

In one embodiment, the first data is transmitted on measurement gaps in the first candidate measurement gap set.

In one embodiment, time-domain resources occupied by the first data conflict with measurement gaps in the first candidate measurement gap set.

In one embodiment, time-domain resources occupied by the first data do not conflict with measurement gaps in the first measurement gap set.

In one embodiment, the first data is transmitted on the first time window set.

In one embodiment, time-domain resources occupied by the first data belong to the first time window set.

In one embodiment, downlink control information (DCI) that schedules first data is transmitted on measurement gaps in the first candidate measurement gap set.

In one embodiment, time-domain resources occupied by DCI that schedules first data conflict with measurement gaps in the first candidate measurement gap set.

In one embodiment, time-domain resources occupied by DCI that schedules first data do not conflict with measurement gaps in the first measurement gap set.

In one embodiment, a second measurement gap does not conflict with the first data in time domain.

In one embodiment, DCI that schedules first data is transmitted on the first time window set.

In one embodiment, time-domain resources occupied by DCI that schedules first data belong to the first time window set.

In one embodiment, the first node U01 performs channel measurement within the first measurement gap set.

In one embodiment, the first measurement report is used for reporting a measurement result of channel measurement performed within the first measurement gap set.

### Embodiment 6

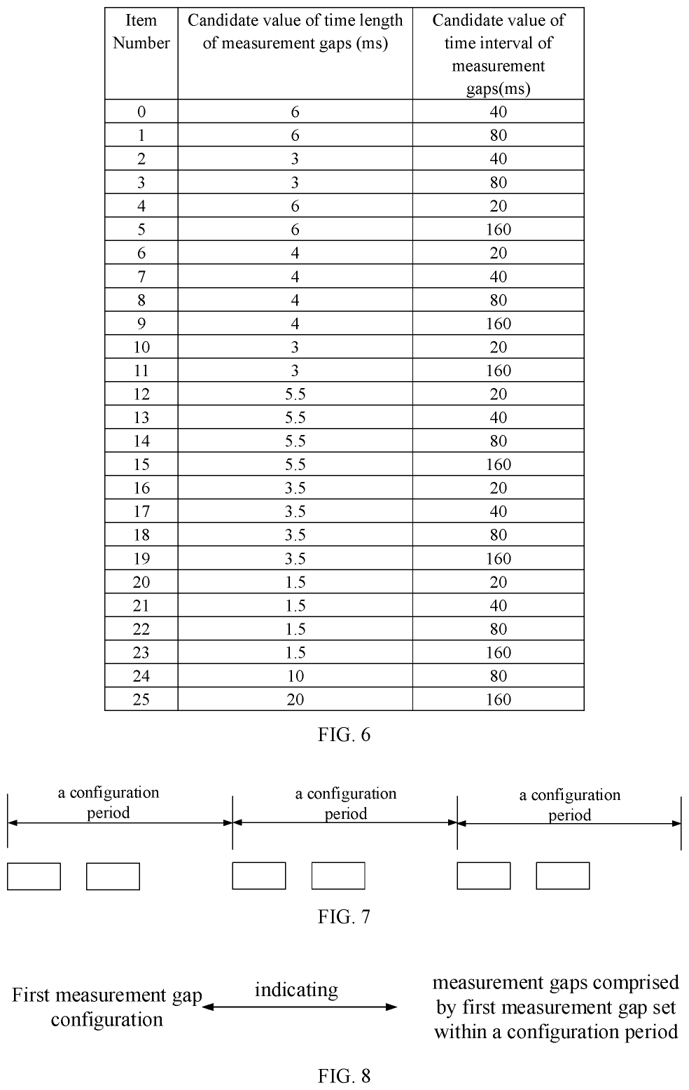

Embodiment 6 illustrates a schematic diagram of measurement gaps according to one embodiment of the present application, as shown in FIG. 6.

FIG. 6 illustrates a total of 26 Configuration templates of the measurement gap, respectively numbered in 0-25; the configuration of measurement gaps is not limited to configurations illustrated in FIG. 6, for instance, to support the method proposed by the present application, other new configuration templates of measurement gaps can be defined.

In one embodiment, candidate values of the time interval of measurement gaps include 20 ms, 40 ms, 80 ms and 160 ms.

In one embodiment, candidate values of the time length of a measurement gap include 1.5 ms, 3 ms, 3.5 ms, 4 ms, 5.5 ms, 6 ms, 10 ms, and 20 ms.

In one embodiment, a measurement gap period indicated by the first measurement gap configuration belongs to candidate values of the time interval of measurement gaps.

In one embodiment, the time interval of measurement gaps indicated by the first measurement gap configuration includes multiple values, where none of the measurement gaps configured by the first measurement gap configuration belongs to the configuration templates indicated by FIG. 6.

In one embodiment, the first signaling indicates a first measurement gap configuration.

In one embodiment, a candidate of the time interval of measurement gaps indicated by the first measurement gap configuration includes 50 ms.

In one embodiment, a candidate of the time interval of measurement gaps indicated by the first measurement gap configuration includes 30 ms.

In one embodiment, a candidate of the time interval of measurement gaps indicated by the first measurement gap configuration includes 25 ms.

In one embodiment, a candidate of the time interval of measurement gaps indicated by the first measurement gap configuration includes 100 ms.

In one embodiment, a time interval between any two adjacent measurement gaps in the first candidate measurement gap set is equal to that between any other two adjacent measurement gaps in the first candidate measurement gap set.

In one embodiment, a time interval between any two adjacent measurement gaps in the first candidate measurement gap set is one of the first time interval or the second time interval.

In one embodiment, a time interval between any two adjacent measurement gaps in the second candidate measurement gap set is equal to that between any other two adjacent measurement gaps in the second candidate measurement gap set.

In one embodiment, a time interval between any two adjacent measurement gaps in the second candidate measurement gap set is one of the first time interval or the second time interval.

### Embodiment 7

Embodiment 7 illustrates a schematic diagram of measurement gaps according to one embodiment of the present application, as shown in FIG. 7.

In one embodiment, each measurement gap comprised by the first measurement gap set has a same position in each configuration period.

In one embodiment, the first measurement gap configuration indicates the configuration period.

In one embodiment, a candidate of a length of the configuration period includes 50 ms.

In one embodiment, the configuration period comprises at least 1 measurement gap.

In one embodiment, the configuration period comprises at least 2 measurement gaps.

In one embodiment, the configuration period comprises at least 3 measurement gaps.

In one embodiment, how many measurement gap(s) is(are) comprised by the configuration period is related to a number of DRX configuration(s) of the first node.

In one embodiment, how many measurement gap(s) is(are) comprised by the configuration period is related to a first time window set.

In one embodiment, how many measurement gap(s) is(are) comprised by the configuration period is related to reception and/or transmission of first service.

In one embodiment, the meaning of the sentence that each measurement gap comprised by the first measurement gap set has a same position in each configuration period comprises that: measurement gaps within each configuration period are periodically repeated.

In one embodiment, the meaning of the sentence that each measurement gap comprised by the first measurement gap set has a same position in each configuration period comprises that: measurement gaps within each configuration period are periodically repeated, where the periodicity of repetitions is equal to the configuration period.

In one embodiment, the meaning of the sentence that each measurement gap comprised by the first measurement gap set has a same position in each configuration period comprises that: if an x-th ms after a configuration period starts is a start of a measurement gap, an x-th ms after a start of another configuration period is undoubtedly a start of a measurement gap.

In one embodiment, the meaning of the sentence that each measurement gap comprised by the first measurement gap set has a same position in each configuration period comprises that: if a y-th ms after a configuration period starts is an end of a measurement gap, a y-th ms after a start of another configuration period is undoubtedly an end of a measurement gap.

In one embodiment, the first measurement gap set comprises at least two measurement gaps in a configuration period.

In one embodiment, the first measurement gap configuration comprises measurement gaps within a configuration period and a length of the configuration period.

In one embodiment, the first measurement gap configuration comprises a first bitmap, the first bitmap indicating measurement gaps within a configuration period.

In one embodiment, the first measurement gap configuration comprises a second bitmap, the second bitmap indicating time-domain resources of measurement gaps not belonging to a configuration period.

In one embodiment, the first measurement gap configuration comprises a second bitmap, the second bitmap indicating time-domain resources not belonging to the first measurement gap set.

In one embodiment, the first measurement gap configuration does not comprise the period of measurement gaps.

### Embodiment 8

Embodiment 8 illustrates a schematic diagram of a first measurement gap indicating measurement gaps comprised by a first measurement gap set in a configuration period according to one embodiment of the present application, as shown in FIG. 8.

In one embodiment, each measurement gap comprised in the configuration period indicated by the first measurement configuration belongs to the first measurement gap set.

In one embodiment, the first measurement configuration indicates that a configuration period comprises multiple measurement gaps.

In one embodiment, the first measurement configuration indicates a length of a configuration period.

In one embodiment, the first measurement configuration indicates an offset of each measurement gap within a configuration period.

In one embodiment, the first measurement configuration indicates a time length of each measurement gap within a configuration period.

In one embodiment, the first measurement configuration indicates a start of each measurement gap within a configuration period.

In one embodiment, the first measurement configuration indicates a number of measurement gap(s) within a configuration period.

In one embodiment, the first measurement configuration indicates type(s) or use(s) of measurement gap(s) within a configuration period.

In one embodiment, the first measurement configuration indicates one or more measurement gaps associated with one radio bearer or one piece of traffic in the first measurement gap set.

In one embodiment, the first measurement configuration indicates at least one measurement gap associated with one radio bearer or one piece of traffic in the first measurement gap set.

In one embodiment, the first measurement configuration indicates at least one measurement gap associated with one radio bearer or one piece of traffic in the first candidate measurement gap set.

In one embodiment, candidates of the time interval of adjacent measurement gaps within a configuration period include a first time interval and a second time interval.

In one embodiment, the first candidate measurement gap set is the first measurement gap set.

In one embodiment, any measurement gap indicated by the first measurement configuration does not conflict with a first time window set.

In one embodiment, any measurement gap indicated by the first measurement configuration does not conflict with reception and/or transmission of first service.

In one embodiment, any measurement gap indicated by the first measurement configuration does not conflict with reception and/or transmission of first radio bearer.

### Embodiment 9

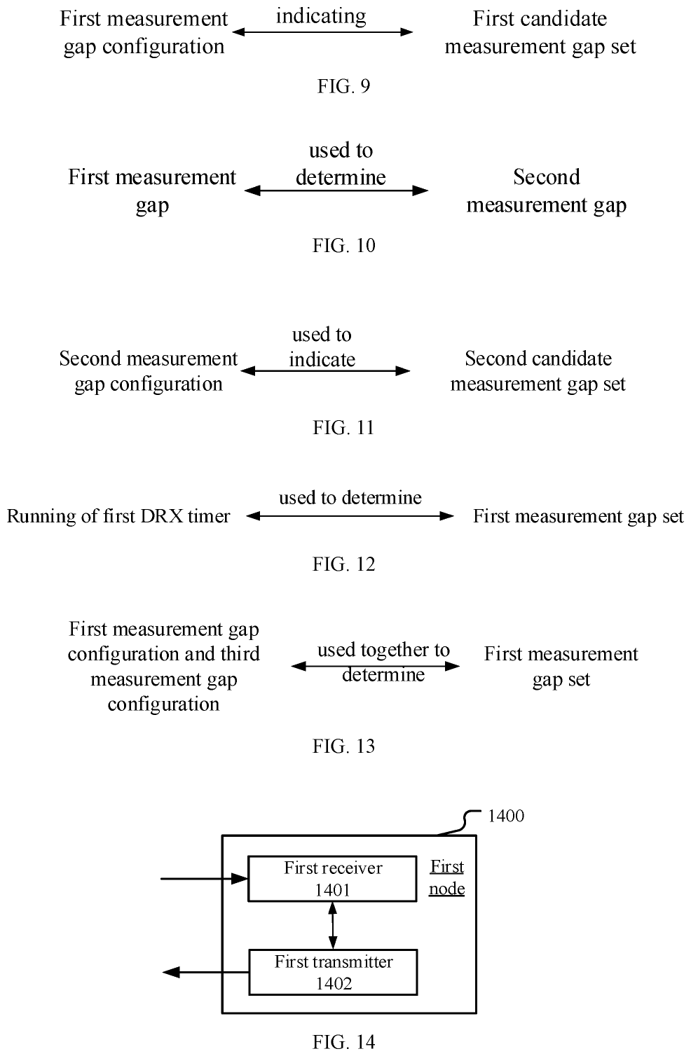

Embodiment 9 illustrates a schematic diagram of a first measurement gap configuration indicating a first candidate measurement gap set according to one embodiment of the present application, as shown in FIG. 9.

In one embodiment, the first measurement gap configuration indicates an offset of each measurement gap in the first candidate measurement gap set.

In one embodiment, the first measurement gap configuration indicates a length of each measurement gap in the first candidate measurement gap set.

In one embodiment, the first measurement gap configuration indicates a period of measurement gaps in the first candidate measurement gap set.

In one embodiment, the first measurement gap configuration indicates a timing advance of measurement gaps in the first candidate measurement gap set.

In one embodiment, the first measurement gap configuration indicates whether a type of measurement gaps in the first candidate measurement gap set is for UE or FR1 or FR2.

In one embodiment, the first measurement gap configuration indicates a cell to which measurement gaps in the first candidate measurement gap set correspond.

In one embodiment, the first measurement gap configuration indicates a priority of each measurement gap in the first candidate measurement gap set.

In one embodiment, the first measurement gap configuration indicates whether measurement gaps in the first candidate measurement gap set support sharing.

In one embodiment, the first measurement gap configuration indicates at least one parameter of measurement gaps in the first candidate measurement gap set.

In one embodiment, the first measurement gap configuration does not indicate a number of measurement gaps in the first candidate measurement gap set.

In one embodiment, the first measurement gap configuration indicates that the first candidate measurement gap set suits one of configurations 0-25 shown in FIG. 6.

In one embodiment, a time interval between any two adjacent measurement gaps in the first candidate measurement gap set is equal to that between any other two adjacent measurement gaps in the first candidate measurement gap set.

### Embodiment 10

Embodiment 10 illustrates a schematic diagram of a first measurement gap being used to determine a second measurement gap according to one embodiment of the present application, as shown in FIG. 10.

In one embodiment, the second measurement gap and the first measurement gap are of equal lengths.

In one embodiment, the second measurement gap is a first one of measurement gaps later than the first measurement gap.

In one embodiment, the second measurement gap is a last one of measurement gaps earlier than the first measurement gap.

In one embodiment, a start of the second measurement gap is determined by a start of the first measurement gap.

In one embodiment, a start of the second measurement gap is determined by a time determined by a start of the first measurement gap plus a first offset, with the first offset being non-zero.

In one embodiment, the first offset is determined by the first node itself.

In one embodiment, the first offset is indicated by the network.

In one embodiment, the first offset is indicated by the first signaling.

In one embodiment, the first offset is less than the first time interval.

In one embodiment, the first offset is less than the second time interval.

In one embodiment, a start of the second measurement gap is determined by a DRX timer.

In one embodiment, a start of a DRX timer is a start of the second measurement gap.

In one embodiment, an end of a DRX timer is a start of the second measurement gap.

In one embodiment, the second measurement gap does not belong to the first time window set.

In one embodiment, the second measurement gap comprises the earliest possible time other than the first time window set after the first measurement gap.

In one embodiment, the second measurement gap belongs to a candidate measurement gap set, the candidate measurement gap set being indicated by the network or determined by the first node itself.

### Embodiment 11

Embodiment 11 illustrates a schematic diagram of a second measurement gap configuration being used to indicate a second candidate measurement gap set according to one embodiment of the present application, as shown in FIG. 11.

In one embodiment, the second measurement gap configuration indicates an offset of each measurement gap in the second candidate measurement gap set.

In one embodiment, the second measurement gap configuration indicates a length of each measurement gap in the second candidate measurement gap set.

In one embodiment, the second measurement gap configuration indicates a period of measurement gaps in the second candidate measurement gap set.

In one embodiment, the second measurement gap configuration indicates a timing advance of measurement gaps in the second candidate measurement gap set.

In one embodiment, the second measurement gap configuration indicates whether a type of measurement gaps in the second candidate measurement gap set is for UE or FR1 or FR2.

In one embodiment, the second measurement gap configuration indicates a cell to which measurement gaps in the second candidate measurement gap set correspond.

In one embodiment, the second measurement gap configuration indicates a priority of each measurement gap in the second candidate measurement gap set.

In one embodiment, the second measurement gap configuration indicates whether measurement gaps in the second candidate measurement gap set support sharing.

In one embodiment, the second measurement gap configuration indicates at least one parameter of measurement gaps in the second candidate measurement gap set.

In one embodiment, the second measurement gap configuration does not indicate a number of measurement gaps in the second candidate measurement gap set.

In one embodiment, the second measurement gap configuration indicates that the second candidate measurement gap set suits one of configurations 0-25 shown in FIG. 6.

In one embodiment, a time interval between any two adjacent measurement gaps in the second candidate measurement gap set is equal to that between any other two adjacent measurement gaps in the second candidate measurement gap set.

In one embodiment, a length of measurement gaps indicated by the second measurement gap configuration is identical to that indicated by the first measurement gap configuration.

In one embodiment, an offset of measurement gaps indicated by the second measurement gap configuration is different from that indicated by the first measurement gap configuration.

In one embodiment, a period of measurement gaps indicated by the second measurement gap configuration is different from that indicated by the first measurement gap configuration.

In one embodiment, a period of measurement gaps indicated by the second measurement gap configuration is identical to that indicated by the first measurement gap configuration.

In one embodiment, a type of measurement gaps indicated by the second measurement gap configuration is identical to that indicated by the first measurement gap configuration.

In one embodiment, the second measurement gap configuration does not exist alone.

In one embodiment, the second measurement gap configuration is dependent on the first measurement gap configuration.

In one embodiment, the first measurement gap set is for traffics.

### Embodiment 12

Embodiment 12 illustrates a schematic diagram of the running of a first DRX timer being used to determine a first measurement gap set according to one embodiment of the present application, as shown in FIG. 12.

In one embodiment, a time while the first DRX timer is running is an Active Time.

In one embodiment, the first node is required to listen over a PDCCH in the Active Time.

In one embodiment, the first DRX timer is a drx-onDurationTimer.

In one embodiment, the first DRX timer is a drx-InactivityTimer.

In one embodiment, a first measurement gap configuration indicates a first candidate measurement gap set.

In one embodiment, a time interval between any two adjacent measurement gaps in the first candidate measurement gap set is equal to that between any other two adjacent measurement gaps in the first candidate measurement gap set.

In one embodiment, the first measurement gap set only comprises measurement gap(s) in the first candidate measurement gap set that is(are) beyond the time while the first DRX timer is running.

In one embodiment, the first node ignores measurement gaps during the time while the first DRX timer is running.

In one embodiment, the first node shall listen over a PDCCH regardless of the existence of measurement gaps during the time while the first DRX timer is running.

In one embodiment, the first node shall receive and transmit first service regardless of the existence of measurement gaps during the time while the first DRX timer is running.

In one embodiment, the first measurement gap set is dependent on DRX configuration.

In one embodiment, any measurement gap in the first measurement gap set corresponds to a fixed length of time after an end of running of the first DRX timer.

In one embodiment, the first measurement gap configuration indicates the fixed length of time.

### Embodiment 13

Embodiment 13 illustrates a schematic diagram of a first measurement gap configuration and a third measurement gap configuration being used together to determine a first measurement gap set according to one embodiment of the present application, as shown in FIG. 13.

In one embodiment, a period of measurement gaps indicated by the third measurement gap configuration is equal to a period of measurement gaps indicated by the first measurement gap configuration.

In one embodiment, an offset of measurement gaps indicated by the third measurement gap configuration is unequal to an offset of measurement gaps indicated by the first measurement gap configuration.

In one embodiment, a period of measurement gaps indicated by the third measurement gap configuration is equal to K times the length of a transmission period of first service.

In one embodiment, a period of measurement gaps indicated by the third measurement gap configuration is equal to K times the length of a reception period of first service.

In one embodiment, a period of measurement gaps indicated by the third measurement gap configuration is equal to K times the length of a period of a first time window set.

In one embodiment, a period of measurement gaps indicated by the third measurement gap configuration is equal to K times the length of a DRX period.

In one embodiment, a period of measurement gaps indicated by the first measurement gap configuration is equal to K times the length of a transmission period of first service.

In one embodiment, a period of measurement gaps indicated by the first measurement gap configuration is equal to K times the length of a reception period of first service.

In one embodiment, a period of measurement gaps indicated by the first measurement gap configuration is equal to K times the length of a period of a first time window set.

In one embodiment, a period of measurement gaps indicated by the first measurement gap configuration is equal to K times the length of a DRX period.

In one embodiment, K is a positive integer.

In one embodiment, K is equal to 3.

In one embodiment, measurement gap configurations in a first measurement gap configuration set are used together for determining a first measurement gap set; the first measurement gap set comprises Z measurement gap configurations, and the first node has a total of Z DRX configurations.

In one embodiment, the third measurement gap configuration indicates a third candidate measurement gap set.

In one embodiment, a time interval between any 2 adjacent measurement gaps in the third candidate measurement gap set is equal to that between any other 2 adjacent measurement gaps in the third candidate measurement gap set.

In one embodiment, the third measurement gap configuration indicates a length of each measurement gap in the third candidate measurement gap set.

In one embodiment, the first measurement gap set comprises the first candidate measurement gap set and the third measurement gap set.

### Embodiment 14

Embodiment 14 illustrates a structure block diagram of a processing device used in a first node according to one embodiment of the present application; as shown in FIG. 14. In FIG. 14, a first node processing device 1400 comprises a first receiver 1401 and a first transmitter 1402. In Embodiment 14,
the first receiver 1401 receives a first signaling, the first signaling comprising a first measurement gap configuration, the first measurement gap configuration comprising that frequencies corresponding to measurement gaps are configured as a first frequency set;
the first receiver 1401 determines a first measurement gap set according to the first measurement gap configuration; the first measurement gap set comprising at least two measurement gaps;
herein, any transmission or reception for a serving cell on the first frequency set within the first measurement gap set other than radio resource management (RRM) measurement and Positioning Reference Signal (PRS) measurement is ignored; any two measurement gaps in the first measurement gap set are orthogonal and non-consecutive in time domain; candidates of a time interval between any two time-domain adjacent measurement gaps in the first measurement gap set include a first time interval and a second time interval, where the first time interval is unequal to the second time interval.

In one embodiment, the first measurement gap configuration indicates measurement gaps comprised by the first measurement gap set within a configuration period, where each measurement gap comprised by the first measurement gap set has a same position in each configuration period.

In one embodiment, the first measurement gap configuration indicates a first candidate measurement gap set; the first measurement gap set only comprises measurement gaps not conflicting with a first time window set in the first candidate measurement gap set; the first time window set comprises at least one time window, and any time window in the first time window set comprises at least one slot.

In one embodiment, the first measurement gap set comprises a second measurement gap, the second measurement gap not belonging to the first candidate measurement gap set; the second measurement gap does not conflict with the first time window set in time domain, a first measurement gap being used to determine the second measurement gap; the first measurement gap belongs to the first candidate measurement gap set but does not belong to the first measurement gap set.

In one embodiment, the first signaling comprises a second measurement gap configuration, the second measurement gap configuration indicating a second candidate measurement gap set;
herein, the second measurement gap belongs to the second candidate measurement gap set; measurement gaps in the second candidate measurement gap set are activated only when measurement gaps in the first candidate measurement gap set conflict with the first time window set in time domain.

In one embodiment, the first signaling comprises a first Discontinuous Reception (DRX) parameter set, the first DRX parameter set being for a first cell group and unrelated to broadcast multicast or sidelink communications; the first DRX parameter set comprises a configuration parameter of a first DRX timer; running of the first DRX timer is used to determine the first measurement gap set.

In one embodiment, the first signaling comprises a third measurement gap configuration and a first measurement object, the first measurement object used for configuring a measurement; the first measurement object indicates a first reference signal resource; a measurement of the first reference signal resource is associated with both a measurement gap configured by the first measurement gap configuration and a measurement gap configured by a third measurement gap configuration;
herein, the first measurement gap configuration and the third measurement gap configuration are used together to determine the first measurement gap set.

In one embodiment, the first DRX timer is unrelated to a timer used in a random access procedure.

In one embodiment, the first DRX timer does not include a ra-Response Window, nor does it include a ra-ContentionResolutionTimer or a msgB-ResponseWindow.

In one embodiment, the first node is a UE.

In one embodiment, the first node is a terminal supporting large delay difference.

In one embodiment, the first node is a terminal supporting NTN.

In one embodiment, the first node is an aircraft or vessel.

In one embodiment, the first node is a cellphone or vehicle-mounted terminal.

In one embodiment, the first node is a relay UE and/or a U2N remote UE.

In one embodiment, the first node is an IoT terminal or IIoT terminal.

In one embodiment, the first node is a piece of equipment supporting transmissions with low delay and high reliability.

In one embodiment, the first node is a sidelink communication node.

In one embodiment, the first receiver 1401 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1402 comprises at least one of the antenna 452, the transmitter 454, the transmitting processor 468, the multi-antenna transmitting processor 457, the controller/processor 459, the memory 460 or the data source 467 in Embodiment 4.

### Embodiment 15

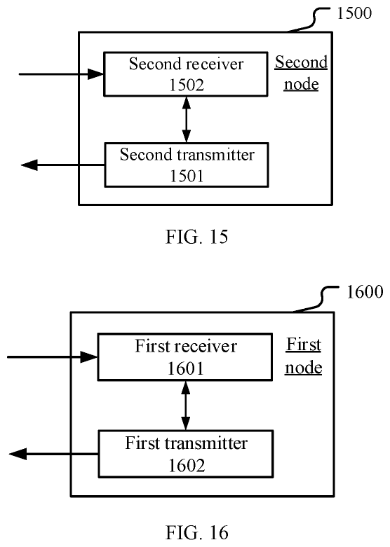

Embodiment 15 illustrates a structure block diagram of a processing device used in a second node according to one embodiment of the present application; as shown in FIG. 15. In FIG. 15, a second node processing device 1500 comprises a second receiver 1502 and a second transmitter 1501. In Embodiment 15,
the second transmitter 1501 transmits a first signaling, the first signaling comprising a first measurement gap configuration, the first measurement gap configuration comprising that frequencies corresponding to measurement gaps are configured as a first frequency set; the first measurement gap configuration being used to determine a first measurement gap set; the first measurement gap set comprising at least two measurement gaps;
herein, any transmission or reception of a receiver of the first signaling for a serving cell on the first frequency set within the first measurement gap set other than RRM measurement and PRS measurement is ignored; any two measurement gaps in the first measurement gap set are orthogonal and non-consecutive in time domain; candidates of a time interval between any two time-domain adjacent measurement gaps in the first measurement gap set include a first time interval and a second time interval, where the first time interval is unequal to the second time interval.

In one embodiment, the first measurement gap configuration indicates measurement gaps comprised by the first measurement gap set within a configuration period, where each measurement gap comprised by the first measurement gap set has a same position in each configuration period.

In one embodiment, the first measurement gap configuration indicates a first candidate measurement gap set; the first measurement gap set only comprises measurement gaps not conflicting with a first time window set in the first candidate measurement gap set; the first time window set comprises at least one time window, and any time window in the first time window set comprises at least one slot.

In one embodiment, the first measurement gap set comprises a second measurement gap, the second measurement gap not belonging to the first candidate measurement gap set; the second measurement gap does not conflict with the first time window set in time domain, a first measurement gap being used to determine the second measurement gap; the first measurement gap belongs to the first candidate measurement gap set but does not belong to the first measurement gap set.

In one embodiment, the first signaling comprises a second measurement gap configuration, the second measurement gap configuration indicating a second candidate measurement gap set; herein, the second measurement gap belongs to the second candidate measurement gap set; measurement gaps in the second candidate measurement gap set are activated only when measurement gaps in the first candidate measurement gap set conflict with the first time window set in time domain.

In one embodiment, the first signaling comprises a first Discontinuous Reception (DRX) parameter set, the first DRX parameter set being for a first cell group and unrelated to broadcast multicast or sidelink communications; the first DRX parameter set comprises a configuration parameter of a first DRX timer; running of the first DRX timer is used to determine the first measurement gap set.

In one embodiment, the first signaling comprises a third measurement gap configuration and a first measurement object, the first measurement object used for configuring a measurement; the first measurement object indicates a first reference signal resource; a measurement of the first reference signal resource is associated with both a measurement gap configured by the first measurement gap configuration and a measurement gap configured by a third measurement gap configuration; herein, the first measurement gap configuration and the third measurement gap configuration are used together to determine the first measurement gap set.

In one embodiment, the second node is a satellite.

In one embodiment, the second node is a U2N relay UE.

In one embodiment, the second node is an IoT node.

In one embodiment, the second node is a wearable node.

In one embodiment, the second node is a base station.

In one embodiment, the second node is a relay.

In one embodiment, the second node is an access point.

In one embodiment, the second node is a multicast-supporting node.

In one embodiment, the second transmitter 1501 comprises at least one of the antenna 420, the transmitter 418, the transmitting processor 416, the multi-antenna transmitting processor 471, the controller/processor 475 or the memory 476 in Embodiment 4.

In one embodiment, the second receiver 1502 comprises at least one of the antenna 420, the receiver 418, the receiving processor 470, the multi-antenna receiving processor 472, the controller/processor 475 or the memory 476 in Embodiment 4.

### Embodiment 16

Embodiment 16 illustrates a structure block diagram of a processing device used in a first node according to one embodiment of the present application; as shown in FIG. 16. In FIG. 16, a first node processing device 1600 is comprised of a first receiver 1601 and a first transmitter 1602. In Embodiment 16,
the first receiver 1601 receives a first signaling, the first signaling comprising a first measurement gap configuration, the first measurement gap configuration comprising that frequencies corresponding to measurement gaps are configured as a first frequency set;
the first receiver 1601 receives a first signal, on a cell in the first frequency set, and within the time in which a first time window set and a first candidate measurement gap set overlap, the first signal belonging to first-type signals; the first-type signals are used for bearing first service;
herein, the first measurement configuration is used for indicating a first candidate measurement gap set; any transmission or reception for a serving cell on the first frequency set within the first measurement gap set other than that of the first-type signals and radio resource management (RRM) measurement and Positioning Reference Signal (PRS) measurement is ignored; any two measurement gaps in the first candidate measurement gap set are orthogonal and non-consecutive in time domain; the first time window set is configurable, where any time window in the first time window set comprises at least one slot.

In one embodiment, the first transmitter 1602 transmits a second signal on a cell in the first frequency set, and within time in which a first time window set and a first candidate measurement gap set overlap; the second signal belongs to the first-type signals, the first-type signals used for bearing first service.

In one embodiment, the first signaling is used to indicate the first time window set.

In one embodiment, the first time window set corresponds to a time of receiving and/or transmitting the first service.

In one embodiment, the first time window set is determined by a QoS parameter of the first service.

In one embodiment, the first-type signals are unrelated to a msg3 or a MSGA.

In one embodiment, the first-type signals are unrelated to an SRS.

In one embodiment, the first-type signals are unrelated to whether a ra-ResponseWindow or a ra-ContentionResolutionTimer or a msgB-ResponseWindow is running.

In one embodiment, none of a ra-ResponseWindow or a ra-ContentionResolutionTimer and a msgB-Response Window of the first node is running.

In one embodiment, the first-type signals include a DCI on a specific search space.

In one embodiment, the first-type signals include a signal within the first time window set.

In one embodiment, the first-type signals include a signal bearing the first service.

In one embodiment, any transmission or reception for a serving cell on the first frequency set within time in the first measurement gap set not overlapping with the first time window set other than radio resource management (RRM) measurement and Positioning Reference Signal (PRS) measurement is ignored.

In one embodiment, the first time window set is related to resource allocation and/or scheduling.

In one subembodiment, the resource allocation and/or scheduling is used for transmitting the first service.

In one embodiment, the first service includes XR service.

In one embodiment, the first service includes low-latency interactive service.

In one embodiment, the first time window set is DRX-related.

In one embodiment, the first time window set is related to specific DRX, where the specific DRX as indicated by the first signaling is associated with the first service or can preempt or ignore measurement gaps.

In one embodiment, the sentence that any transmission or reception for a serving cell on the first frequency set within the first measurement gap set other than that of the first-type signals and radio resource management (RRM) measurement and Positioning Reference Signal (PRS) measurement is ignored means that: any transmission or reception for a serving cell on the first frequency set within time in which the first measurement gap set overlaps with the first time window set other than that of the first-type signals and radio resource management (RRM) measurement and Positioning Reference Signal (PRS) measurement is ignored.

In one embodiment, the first node is a UE.

In one embodiment, the first node is a terminal supporting large delay difference.

In one embodiment, the first node is a terminal supporting NTN.

In one embodiment, the first node is an aircraft or vessel.

In one embodiment, the first node is a cellphone or vehicle-mounted terminal.

In one embodiment, the first node is a relay UE and/or a U2N remote UE.

In one embodiment, the first node is an IoT terminal or IIoT terminal.

In one embodiment, the first node is a piece of equipment supporting transmissions with low delay and high reliability.

In one embodiment, the first node is a sidelink communication node.

In one embodiment, the first receiver 1601 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1602 comprises at least one of the antenna 452, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (JOT), RFID terminals, NB-JOT terminals, Machine Type Communication (MTC) terminals, enhanced MTC (eMTC) terminals, data cards, low-cost mobile phones, low-cost tablet computers, satellite communication equipment, ship communication equipment, and NTN UE, etc. The base station or system device in the present application includes but is not limited to macro-cellular base stations, micro-cellular base stations, home base stations, relay base station, gNB (NR node B), Transmitter Receiver Point (TRP), NTN base station, satellite equipment and fight platform, and other radio communication equipment.

This disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling, the first signaling comprising a first measurement gap configuration, the first measurement gap configuration comprising that frequencies corresponding to measurement gaps are configured as a first frequency set;
the first receiver, determining a first measurement gap set according to the first measurement gap configuration; the first measurement gap set comprising at least two measurement gaps;
wherein any transmission or reception for a serving cell on the first frequency set within the first measurement gap set other than radio resource management (RRM) measurement and Positioning Reference Signal (PRS) measurement is ignored; any two measurement gaps in the first measurement gap set are orthogonal and non-consecutive in time domain; candidates of a time interval between any two time-domain adjacent measurement gaps in the first measurement gap set include a first time interval and a second time interval, where the first time interval is unequal to the second time interval.

2. The first node according to claim 1, characterized in that
the first measurement gap configuration indicates measurement gaps comprised by the first measurement gap set within a configuration period, where each measurement gap comprised by the first measurement gap set has a same position in each configuration period.

3. The first node according to claim 1, characterized in that
the first measurement gap configuration indicates a first candidate measurement gap set; the first measurement gap set only comprises measurement gaps not conflicting with a first time window set in the first candidate measurement gap set; the first time window set comprises at least one time window, and any time window in the first time window set comprises at least one slot.

4. The first node according to claim 3, characterized in that
the first measurement gap set comprises a second measurement gap, the second measurement gap not belonging to the first candidate measurement gap set; the second measurement gap does not conflict with the first time window set in time domain, a first measurement gap being used to determine the second measurement gap; the first measurement gap belongs to the first candidate measurement gap set but does not belong to the first measurement gap set.

5. The first node according to claim 4, characterized in that
the first signaling comprises a second measurement gap configuration, the second measurement gap configuration indicating a second candidate measurement gap set;
wherein the second measurement gap belongs to the second candidate measurement gap set; measurement gaps in the second candidate measurement gap set are activated only when measurement gaps in the first candidate measurement gap set conflict with the first time window set in time domain.

6. The first node according to claim 1, characterized in that
the first signaling comprises a first Discontinuous Reception (DRX) parameter set, the first DRX parameter set being for a first cell group and unrelated to broadcast multicast or sidelink communications; the first DRX parameter set comprises a configuration parameter of a first DRX timer; running of the first DRX timer is used to determine the first measurement gap set.

7. The first node according to claim 2, characterized in that
the first signaling comprises a first Discontinuous Reception (DRX) parameter set, the first DRX parameter set being for a first cell group and unrelated to broadcast multicast or sidelink communications; the first DRX parameter set comprises a configuration parameter of a first DRX timer; running of the first DRX timer is used to determine the first measurement gap set.

8. The first node according to claim 3, characterized in that
the first signaling comprises a first Discontinuous Reception (DRX) parameter set, the first DRX parameter set being for a first cell group and unrelated to broadcast multicast or sidelink communications; the first DRX parameter set comprises a configuration parameter of a first DRX timer; running of the first DRX timer is used to determine the first measurement gap set.

9. The first node according to claim 4, characterized in that
the first signaling comprises a first Discontinuous Reception (DRX) parameter set, the first DRX parameter set being for a first cell group and unrelated to broadcast multicast or sidelink communications; the first DRX parameter set comprises a configuration parameter of a first DRX timer; running of the first DRX timer is used to determine the first measurement gap set.

10. The first node according to claim 5, characterized in that
the first signaling comprises a first Discontinuous Reception (DRX) parameter set, the first DRX parameter set being for a first cell group and unrelated to broadcast multicast or sidelink communications; the first DRX parameter set comprises a configuration parameter of a first DRX timer; running of the first DRX timer is used to determine the first measurement gap set.

11. The first node according to claim 1, characterized in that
the first signaling comprises a third measurement gap configuration and a first measurement object, the first measurement object used for configuring a measurement; the first measurement object indicates a first reference signal resource; a measurement of the first reference signal resource is associated with both a measurement gap configured by the first measurement gap configuration and a measurement gap configured by a third measurement gap configuration;
wherein the first measurement gap configuration and the third measurement gap configuration are used together to determine the first measurement gap set.

12. The first node according to claim 2, characterized in that
the first signaling comprises a third measurement gap configuration and a first measurement object, the first measurement object used for configuring a measurement; the first measurement object indicates a first reference signal resource; a measurement of the first reference signal resource is associated with both a measurement gap configured by the first measurement gap configuration and a measurement gap configured by a third measurement gap configuration;
wherein the first measurement gap configuration and the third measurement gap configuration are used together to determine the first measurement gap set.

13. The first node according to claim 3, characterized in that
the first signaling comprises a third measurement gap configuration and a first measurement object, the first measurement object used for configuring a measurement; the first measurement object indicates a first reference signal resource; a measurement of the first reference signal resource is associated with both a measurement gap configured by the first measurement gap configuration and a measurement gap configured by a third measurement gap configuration;
wherein the first measurement gap configuration and the third measurement gap configuration are used together to determine the first measurement gap set.

14. The first node according to claim 4, characterized in that
the first signaling comprises a third measurement gap configuration and a first measurement object, the first measurement object used for configuring a measurement; the first measurement object indicates a first reference signal resource; a measurement of the first reference signal resource is associated with both a measurement gap configured by the first measurement gap configuration and a measurement gap configured by a third measurement gap configuration;
wherein the first measurement gap configuration and the third measurement gap configuration are used together to determine the first measurement gap set.

15. The first node according to claim 5, characterized in that
the first signaling comprises a third measurement gap configuration and a first measurement object, the first measurement object used for configuring a measurement; the first measurement object indicates a first reference signal resource; a measurement of the first reference signal resource is associated with both a measurement gap configured by the first measurement gap configuration and a measurement gap configured by a third measurement gap configuration;
wherein the first measurement gap configuration and the third measurement gap configuration are used together to determine the first measurement gap set.

16. The first node according to claim 3, characterized in that
when the first signaling indicates that the first node shall ignore measurement gaps on the first time window set, the first measurement gap set is different from the first candidate measurement gap set; when the first signaling does not indicate that the first node shall ignore measurement gaps on the first time window set, the first measurement gap set is identical to the first candidate measurement gap set.

17. The first node according to claim 3, characterized in that
the first signaling indicates measurement gap(s) that can be deactivated or ignored in the first candidate measurement gap set.

18. The first node according to claim 1, characterized in that
the action of determining a first measurement gap set according to the first measurement gap configuration is related to configuration of a first radio bearer (RB); the first RB is used for transmitting eXtended Reality (XR) traffics.

19. A second node for wireless communications, comprising:
a second transmitter, transmitting a first signaling, the first signaling comprising a first measurement gap configuration, the first measurement gap configuration comprising that frequencies corresponding to measurement gaps are configured as a first frequency set; the first measurement gap configuration being used to determine a first measurement gap set; the first measurement gap set comprising at least two measurement gaps;
wherein any transmission or reception of a receiver of the first signaling for a serving cell on the first frequency set within the first measurement gap set other than RRM measurement and PRS measurement is ignored; any two measurement gaps in the first measurement gap set are orthogonal and non-consecutive in time domain; candidates of a time interval between any two time-domain adjacent measurement gaps in the first measurement gap set include a first time interval and a second time interval, where the first time interval is unequal to the second time interval.

20. A method in a first node for wireless communications, comprising:
receiving a first signaling, the first signaling comprising a first measurement gap configuration, the first measurement gap configuration comprising that frequencies corresponding to measurement gaps are configured as a first frequency set; and
determining a first measurement gap set according to the first measurement gap configuration; the first measurement gap set comprising at least two measurement gaps;
wherein any transmission or reception for a serving cell on the first frequency set within the first measurement gap set other than radio resource management (RRM) measurement and Positioning Reference Signal (PRS) measurement is ignored; any two measurement gaps in the first measurement gap set are orthogonal and non-consecutive in time domain; candidates of a time interval between any two time-domain adjacent measurement gaps in the first measurement gap set include a first time interval and a second time interval, where the first time interval is unequal to the second time interval.
